(19) United States
(12) Patent Application Publication
(10) Pub. No.: US 2013/0301295 A1
(43) Pub. Date: Nov. 14, 2013

(54) PLANAR LIGHTING DEVICE

(71) Applicant: FUJIFILM CORPORATION, Tokyo (JP)

(72) Inventor: Osamu IWASAKI, Kanagawa (JP)

(73) Assignee: FUJIFILM CORPORATION, Tokyo (JP)

(21) Appl. No.: 13/946,477

(22) Filed: Jul. 19, 2013

Related U.S. Application Data
(63) Continuation of application No. PCT/JP2011/079653, filed on Dec. 21, 2011.

(30) Foreign Application Priority Data
Jan. 28, 2011 (JP) 2011-016196

(51) Int. Cl. F21V 8/00; F21V 7/00

(52) U.S. Cl. CPC G02B 6/0091; F21V 7/00
USPC 362/609; 362/613

(57) ABSTRACT

The invention provides a planar lighting device in which a reduction in light use efficiency based on the expansion and contraction or warpage of the light guide plate due to the heat or moisture absorption and the deformation of the light guide plate due to the vibration or the like is prevented, and also entering light is guided to the depths of the light guide plate to realize uniform illumination. The object is attained by providing the planar lighting device with a plurality of fixing spring members that press and hold the light guide sheet and light source units in a direction perpendicular to the light exit surface of the light guide sheet, that have elasticity in a direction perpendicular to the light exit surface, and that are arranged in a longitudinal direction of the light incidence surface of the light guide sheet.

### BACKGROUND OF THE INVENTION

The present invention relates to a planar lighting device having a light guide plate and a light source that is used to illuminate the inside or outside of a building, or is used as a backlight for illuminating a liquid crystal panel of a liquid crystal display or a backlight of an advertisement panel, an advertisement pillar, a signboard, or the like.

A liquid crystal display uses a planar lighting device (a backlight unit) which illuminates a liquid crystal display panel by irradiation with light from the back side of the liquid crystal display panel. The backlight unit is configured using a light guide plate for diffusing light emitted from an illumination light source to illuminate the liquid crystal display panel and parts such as a prism sheet and a diffusion sheet for making outgoing light from the light guide plate uniform.

Currently, large-sized liquid crystal televisions predominantly use a so-called underneath type backlight unit including a light guide plate disposed immediately above an illumination light source. This type of backlight unit ensures uniform light intensity distribution and necessary luminance by disposing a plurality of cold cathode tubes used as light sources behind the liquid crystal display panel and providing the inside of the backlight unit with white reflection surfaces.

However, the underneath type backlight unit requires a thickness of about 30 mm in a direction perpendicular to the liquid crystal display panel in order to make the light intensity distribution uniform. Accordingly, further reduction in thickness is difficult to achieve.

On the other hand, an exemplary backlight unit that allows the thickness reduction includes one using a light guide plate which receives light emitted from an illumination light source and enters from a side surface (light incidence surface), guides the received light in predetermined directions, and emits the guided light through a light exit surface that is different from the surface through which the light entered.

As the backlight unit using the light guide plate as described above, there has been proposed a backlight unit of a type of forming light-emitting patterns on the front surface (light exit surface) of a light guide plate or the opposite surface (back surface) thereof through printing, laser patterning, inkjet, or the like or a type of kneading and dispersing scattering particles for scattering light in a light guide plate.

Expansion and contraction or warpage occurs in a light guide plate due to heat or moisture. Accordingly, the backlight unit having a light source disposed on a side surface of the light guide plate has a problem in that the relative position or distance between the light incidence surface of the light guide plate and the light source varies due to the expansion and contraction or the warpage of the light guide plate and light use efficiency is lowered. Alternatively, the positional relationship between the light guide plate and the light source may vary due to vibration and the light use efficiency may be lowered. Accordingly, various mechanisms for fixing the relative position between the light incidence surface of the light guide plate and the light source have been proposed.

For example, JP 2004-253187 A discloses an illumination unit having a reflector (light source support member) for surrounding a light source and holding the light source, in which a cross-section of the light source support member has a substantial U shape, a claw portion is disposed at each end thereof, and the claw portions are fitted to concave portions formed in a light guide plate to fix the relative position between the light guide plate and the light source, thereby coping with expansion and contraction of the light guide plate.

In addition, JP 2006-185724 A discloses a planar lighting device in which point light sources are pressed to a side end surface (light incidence surface) of a light guide plate by pressing means having an elastic deformation portion so as to hold the coupling of the light guide plate and the light sources, thereby coping with the expansion and contraction of the light guide plate.

In addition, JP 2009-93939 A discloses a planar lighting device having fixing means for fixing a light guide plate and a light source and coping with the expansion and contraction of the light guide plate by elastically supporting the fixing means with respect to a housing.

### SUMMARY OF THE INVENTION

With an increase in size of a liquid crystal display, in a backlight unit, an increase in size and a decrease in thickness and weight are required. In addition, there is a need for a planar lighting device which can be used as a decorative illumination or a general illumination as well as a liquid crystal display by making a light guide plate flexible, that is, making a light guide plate have flexibility, and forming the surface of the light guide plate with various curves in addition to the decrease in thickness.

The mechanism as disclosed in JP 2004-253187 A, in which a light source support member for supporting a light source is provided with a claw portion and the claw portion is fitted to a concave portion formed in a light guide plate to fix the relative position between the light guide plate and the light source, can cope with the expansion and contraction of the light guide plate in a direction perpendicular to the light incidence surface. However, in the mechanism, the expansion and contraction of the light guide plate in the longitudinal direction of the light incidence surface is regulated, and accordingly, warpage occurs in a direction perpendicular to the light exit surface of the light guide plate.

In addition, in the mechanism as disclosed in JP 2006-185724 A, in which the coupling of the light guide plate and the light source is held by pressing the light source to the light incidence surface of the light guide plate by the use of the pressing means, there is a possibility that the optical axes is offset to lower light incidence efficiency when the light guide plate decreases in thickness or is made to be flexible.

In addition, in the mechanism as disclosed in JP 2009-93939 A, which has the fixing means for fixing the light guide plate and the light source and elastically supports the fixing means with respect to the housing, there is a possibility that mechanical strength is not sufficient when the light guide plate decreases in thickness.

An object of the present invention is to solve the problems associated with the foregoing prior art and to provide a planar lighting device in which even if a light guide plate (light guide sheet) having a large size, a small thickness, and flexibility is used, the distance and position relationship between the light incidence surface of the light guide plate and an LED or the like as a light source can be appropriately maintained even when expansion and contraction or warpage occurs in the light guide plate due to heat or moisture absorption or the light guide plate is deformed due to vibration or the like, thereby preventing a reduction in light use efficiency based on the expansion and contraction or warpage of the light guide plate due to the heat or moisture absorption and the deformation of the light guide plate due to the vibration or the like, and also guiding the light which enters to the light guide plate to the depths of the light guide plate to realize uniform illumination.

In order to attain the above-described object, the present invention provides a planar lighting device including: a light guide sheet having a rectangular light exit surface, one or more light incidence surfaces, the one light incidence surface being disposed on an end side of the light exit surface and to which light traveling in a direction parallel to the light exit surface enters, and a rear surface which is an opposite surface of the light exit surface; one or more light source units, the one light source having a light source disposed to face the one light incidence surface of the light guide sheet and a light source support member that supports the light source; and a plurality of fixing spring members that press and hold the light guide sheet and the one or more light source units in a direction perpendicular to the light exit surface of the light guide sheet, that have elasticity in a direction perpendicular to the light exit surface, and that are arranged in a longitudinal direction of the one light incidence surface of the light guide sheet.

Preferably, each fixing spring member is a clip member which has a substantially C shape and of which two opening ends hold the light guide sheet and the one or more light source units by pinching and pressing the light guide sheet and the one or more light source units.

Or, preferably, the light source support member has a portion overlapping with the light guide sheet in a direction perpendicular to the light exit surface, and each fixing spring member is a clip member which has a substantially C shape and which holds the light source support member and the light guide sheet in a state where a part of the light source support member and the light guide sheet overlap with each other in the direction perpendicular to the light exit surface by causing one opening edge to press the light source support member and the light guide sheet in the direction perpendicular to the light exit surface from a side closer to the light guide sheet and causing the other opening edge to press the light source support member and the light guide sheet in the direction perpendicular to the light exit surface from a side closer to the light source support member.

Or, preferably, each fixing spring member includes a first fixing spring member that is fixed to the light source support member so as to press the light guide sheet from a side closer to the rear surface and a second fixing spring member that is fixed to the light source support member so as to press the light guide sheet from a side closer to the light exit surface.

Preferably, the light exit surface of the light guide sheet is provided with a plurality of locking holes arranged and formed in a longitudinal direction of the one light incidence surface in the vicinity of the one light incidence surface, and a portion of each fixing spring member which presses the light guide sheet from the side of the light exit surface is provided with a convex portion engaging with the locking hole.

It is preferable that the planar lighting device further include side fixing members that are fixed to the light source support member, that extend to face two side surfaces which are adjacent to the light exit surface and the one or more light incidence surfaces of the light guide sheet, that have convex engaging portions toward the side surfaces, and that have elasticity in the direction perpendicular to the side surfaces of the light guide sheet, that notches be formed on the side surfaces of the light guide sheet, respectively, and that the engaging portions of the side fixing members engage with the notches formed on the side surfaces of the light guide sheet.

Preferably, the thickness of the light guide sheet in the direction perpendicular to the light exit surface is equal to or less than 2 mm.

Preferably, one or more ends of at least one of the light exit surface and the rear surface of the light guide sheet closer to the one or more light incidence surfaces are provided with one or more reflecting members.

Preferably, the one reflecting member includes a plurality of light guide reflectors arranged in an extending direction of the one light incidence surface and adheres to the end of the light exit surface or of the rear surface of the light guide sheet closer to the one light incidence surface.

Further, preferably, each light guide reflector is disposed to partially overlap with adjacent light guide reflectors.

Preferably, the light source includes a plurality of point light sources facing the one or more light incidence surfaces and arranged in an extending direction of the one or more light incidence surfaces.

Preferably, a surface of the light guide sheet is covered with a hard coating material which is optically transparent.

Further, preferably, the hard coating material has a refractive index of 1.43 to 1.65.

Preferably, the light guide sheet has scattering particles kneaded and dispersed therein.

Further, preferably, the light guide sheet has two or more layers which are superposed in a direction perpendicular to the light exit surface and which have different particle concentrations of the scattering particles.

Preferably, the light incidence surfaces consist of two light incidence surfaces disposed on two end sides of the light exit surface facing each other, and the light source units consist of two light source units which are arranged to face the two light incidence surfaces, respectively.

Or, preferably, the one light incidence surface is disposed on an end side of the light exit surface, and the one light source unit is arranged to face the single light incidence surface.

According to the present invention, since a plurality of fixing spring members which press and hold the light guide sheet and the light source unit in a direction perpendicular to the light exit surface of the light guide sheet are arranged in the longitudinal direction of the light incidence surface of the light guide sheet, it is possible to appropriately maintain the distance and position relationship between the light incidence surface of the light guide sheet and the light source even when the light guide sheet having a large size, a small thickness, and flexibility is used, it is possible to prevent a reduction in light use efficiency based on the expansion and contraction or warpage of the light guide sheet due to the heat or moisture absorption and the deformation of the light guide sheet due to the vibration or the like, and it is also possible to realize uniform illumination.

### BRIEF DESCRIPTION OF THE DRAWINGS

FIG. 1 is a schematic perspective view showing an embodiment of a liquid crystal display provided with a planar lighting device according to the present invention.

FIG. 2 is a cross-sectional view of the liquid crystal display shown in FIG. 1 taken along line II-II.

FIG. 3A is a view of the planar lighting device shown in FIG. 2 taken along line III-III and FIG. 3B is a cross sectional view of FIG. 3A taken along line B-B.

FIG. 4A is a perspective view showing the schematic configuration of a light source unit of the planar lighting device shown in FIGS. 1 and 2, and FIG. 4B is an enlarged schematic perspective view showing one of LEDs forming the light source unit shown in FIG. 4A.

FIG. 5 is a schematic perspective view showing the shape of a light guide sheet shown in FIG. 3A.

FIG. 6 is a schematic perspective view showing a part of the backlight unit shown in FIG. 3A.

FIG. 7 is a plan view showing the backlight unit shown in FIG. 2.

FIG. 8 is a cross-sectional view schematically showing a part of another example of the backlight unit.

FIG. 9 is a perspective view schematically showing a part of another example of the backlight unit.

FIG. 10 is a cross-sectional view of FIG. 9 taken along line D-D.

FIG. 11 is a cross-sectional view schematically showing a part of another example of the backlight unit.

FIG. 12 is a cross-sectional view schematically showing a part of another example of the backlight unit.

FIG. 13 is a cross-sectional view schematically showing a part of another example of the backlight unit.

### DETAILED DESCRIPTION OF THE INVENTION

A planar lighting device according to the invention will be described below in detail with reference to preferred embodiments shown in the accompanying drawings.

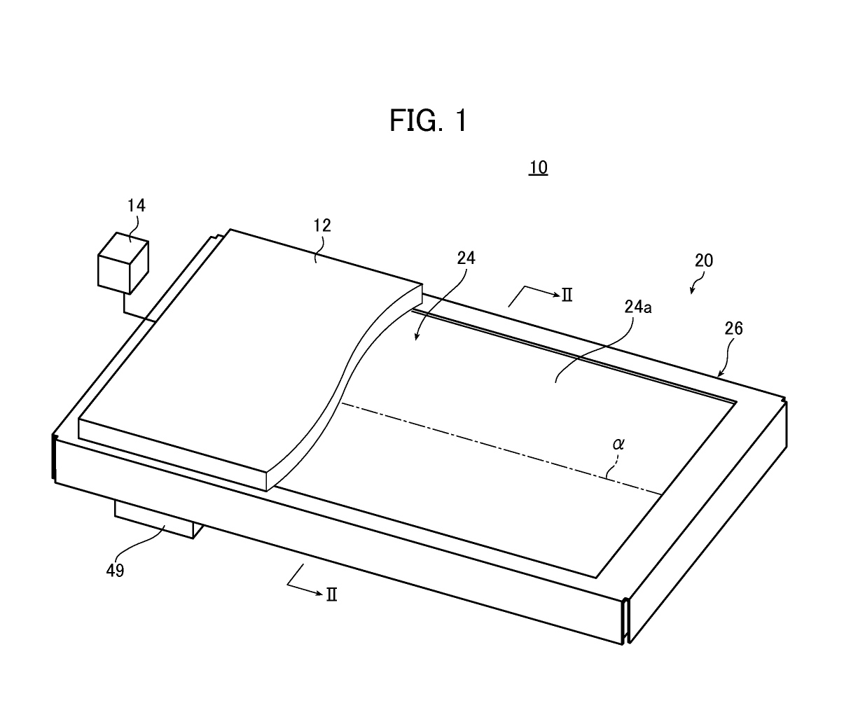

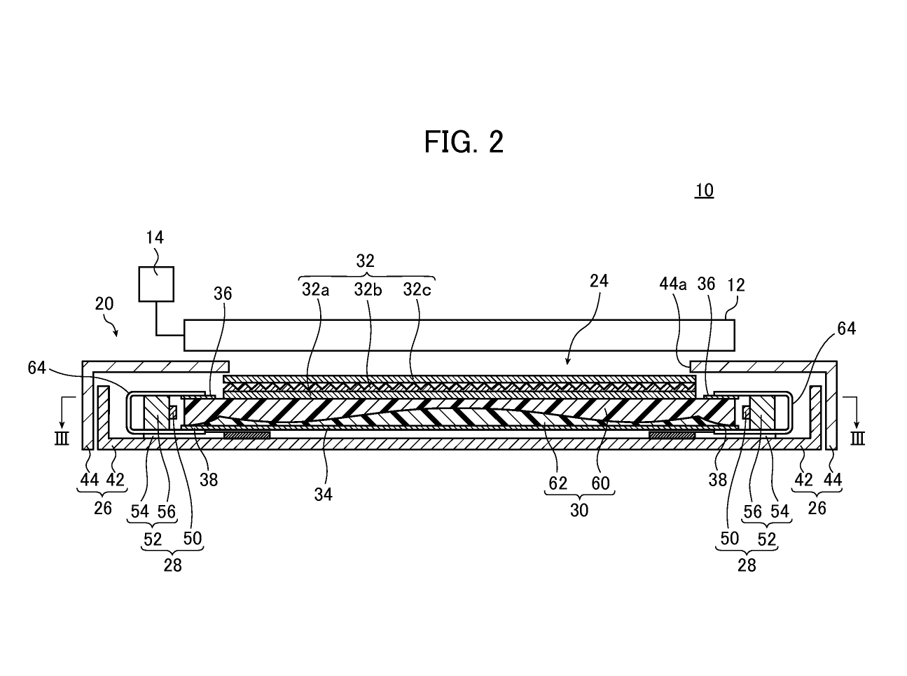

FIG. 1 is a perspective view schematically showing a liquid crystal display provided with the planar lighting device according to the invention and FIG. 2 is a cross-sectional view of the liquid crystal display of FIG. 1 taken along line II-II.

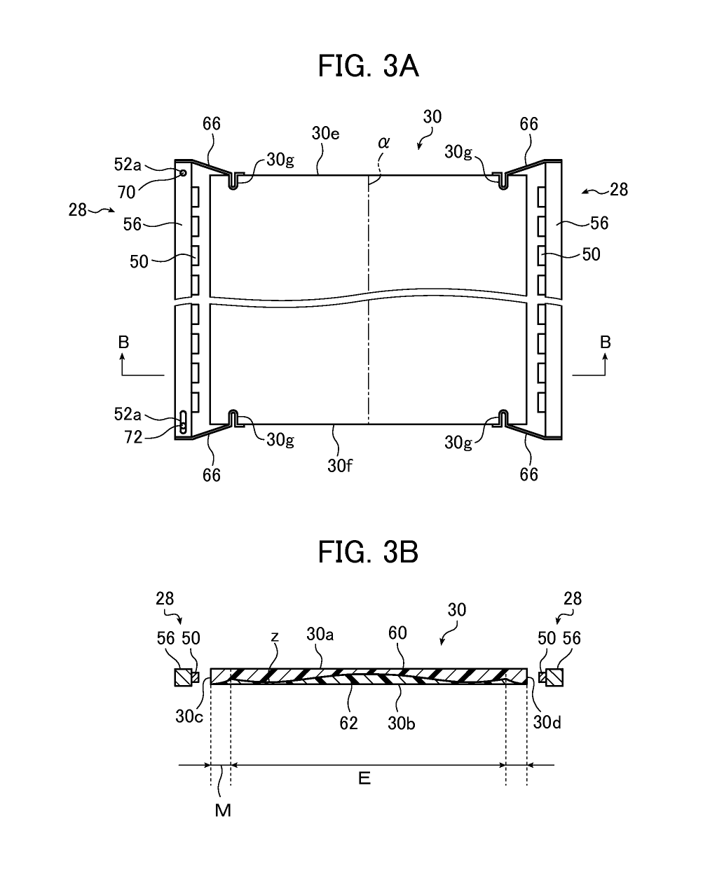

FIG. 3A is a view of the planar lighting device (also referred to below as “backlight unit”) shown in FIG. 2 taken along line and FIG. 3B is a cross-sectional view of FIG. 3A taken along line B-B.

A liquid crystal display 10 comprises a backlight unit 20, a liquid crystal display panel 12 disposed on the side closer to the light exit surface of the backlight unit 20, and a drive unit 14 for driving the liquid crystal display panel 12. In FIG. 1, parts of the liquid crystal display panel 12 are not shown to illustrate the configuration of the backlight unit.

Furthermore, a substrate part 54 of a light source unit 28 is not shown in FIGS. 3A and 3B.

In the liquid crystal display panel 12, an electric field is partially applied to liquid crystal molecules previously arranged in a specified direction to thereby change the orientation of the molecules. The resultant changes in refractive index having occurred in the liquid crystal cells are used to display characters, figures, images and the like on the surface of the liquid crystal display panel 12.

The drive unit 14 applies a voltage to transparent electrodes in the liquid crystal display panel 12 to change the orientation of the liquid crystal molecules, thereby controlling the transmittance of light passing through the liquid crystal display panel 12.

The backlight unit 20 is a lighting device for illuminating the whole surface of the liquid crystal display panel 12 from the back side of the liquid crystal display panel 12 and comprises a light exit surface 24a of which the shape is substantially the same as an image display surface of the liquid crystal display panel 12.

As shown in FIGS. 1, 2, 3A, and 3B, the backlight unit 20 according to this embodiment comprises a lighting device main body 24 having two light source units 28, a light guide sheet (light guide plate) 30, a plurality of clips 64, a side fixing member 66, and an optical member unit 32 and a housing 26 having a lower housing 42 and an upper housing 44. As shown in FIG. 1, a power unit casing 49 containing a plurality of power supplies for supplying the light source units 28 with electric power is disposed on the back side of the lower housing 42 of the housing 26.

Components constituting the backlight unit 20 will be described below.

The lighting device main body 24 comprises the light source units 28 for emitting light, the light guide sheet 30 for emitting the light from the light source units 28 as planar light, the optical member unit 32 for scattering or condensing the light emitted from the light guide sheet 30 to further reduce the unevenness of the light and increase the front luminance thereof, and the plurality of clips 64 for holding the light source units 28 and the light guide sheet 30.

First, the light source units 28 will be described.

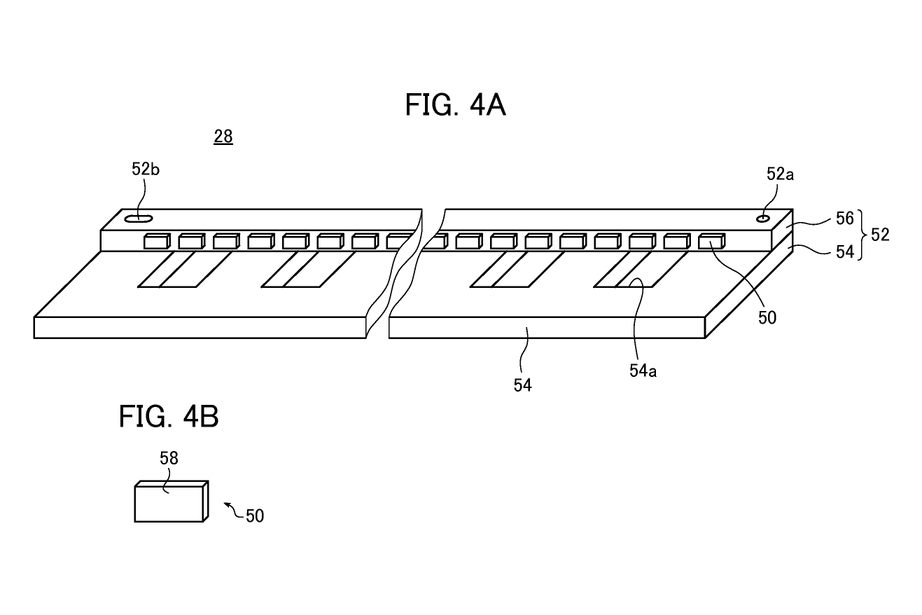

FIG. 4A is a schematic perspective view schematically showing the configuration of the light source unit 28 of the backlight unit 20 shown in FIGS. 1 and 2. FIG. 4B is an enlarged schematic perspective view showing only one LED chip of the light source unit 28 shown in FIG. 4A.

As shown in FIG. 4A, the light source unit 28 comprises a plurality of light emitting diode chips (referred to below as “LED chips”) 50 and a light source support 52.

The LED chip 50 is a chip of a light emitting diode emitting blue light, which has a phosphor applied to the surface thereof. The LED chip 50 has a light-emitting face 58 with a predetermined area and emits white light from the light-emitting face 58.

Specifically, when blue light emitted from the surface of the light emitting diode of the LED chip 50 passes through the phosphor, the phosphor emits fluorescence. Thus, the blue light emitted from the light emitting diode is combined with the light emitted as a result of the fluorescence of the phosphor to produce white light, which is emitted from the LED chip 50.

Examples of the LED chip 50 include chips obtained by applying a YAG (yttrium aluminum garnet) phosphor to the surface of a GaN light emitting diode, an InGaN light emitting diode, and the like.

The light source support 52 is a member for holding the LED chips 50 so that they faces a light incidence surface (30c or 30d) of the light guide sheet 30, and has a support section 56 and a substrate section 54.

The support section 56 is a member which has a rectangular cross-section in the longitudinal direction and one surface of which is disposed to face the light incidence face (30c or 30d) of the light guide sheet 30.

The support section 56 supports the plurality of LED chips 50 on the surface facing the light incidence surface (30c or 30d) of the light guide sheet 30 in a state where the LED chips 50 are spaced from each other at predetermined intervals. Specifically, the plurality of LED chips 50 constituting the light source unit 28 are arranged in an array along the longitudinal direction of a first light incidence surface 30c or the second light incidence surface 30d of the light guide sheet 30 to be described later and are fixed onto the support section 56.

The support section 56 is formed of a metal having high heat conductivity such as copper or aluminum and also serves as a heat sink absorbing heat generated from the LED chips 50 and dissipating the generated heat to the outside. The support section 56 may be provided with fins capable of increasing the surface area and the heat dissipation effect or heat pipes for transferring heat to a heat dissipating member.

The substrate section 54 is a plate-like member that is formed on the surface of the support section 56 facing the back surface 30b of the light guide sheet 30 and extends on the back surface 30b of the light guide sheet 30. At the end portion of the substrate section 54 close to the support section 56, a plurality of clip insertion portions 54a which are rectangular notches through which the clips 64 to be described later are inserted are formed in the arrangement direction of the LED chips 50.

The clip insertion portions 54a are formed to correspond to the arrangement of the clips 64.

The substrate section 54 is formed by pasting a flexible plastic circuit (FPC) to a substrate of a metal having high heat conductivity such as aluminum. The substrate section 54 may be formed of the FPC, but it is preferable that the FPC be pasted to a metal substrate, in that heat generated from the LED chips 50 is efficiently dissipated.

In the backlight unit 20 shown in the drawing, the first light incidence surface 30c of the light guide sheet 30 is located on the upper side in the vertical direction and the second light incidence surface 30d is located on the lower side in the vertical direction. A round hole 52a engaging with a fixing pin 70 to be described later is formed at one corner of the light source support 52 (the support section 56 and the substrate section 54) of the light source unit 28 disposed to be close to the first light incidence surface 30c located on the upper side in the vertical direction, and a long hole 52b having a long axis the direction of which is the arrangement direction of the LED chips 50 and engaging with a fixing pin 72 is formed at the other corner thereof.

By causing the round hole 52a and the long hole 52b to engage with the fixing pins 70 and 72 disposed in the housing, respectively, the light source unit 28 and the light guide sheet 30 held integrally with the light source unit 28 by the clips 64 to be described later are suspended and held by the housing 26.

The light source unit 28 located on the lower side (the side of the second light incidence surface 30d) in the vertical direction is not locked to the housing.

By causing the round hole 52a of the light source support 52 to engage with the fixing pin 70, causing the long hole 52b to engage with the fixing pin 72, and suspending and holding the light source unit 28 and the light guide sheet 30 held integrally with the light source unit 28 by the clips 64 with respect to the housing 26, the light guide sheet 30 is held such that it can expand and contract in the direction perpendicular to the light incidence surface even when the light guide sheet 30 expands or contracts due to heat or moisture absorption. Accordingly, it is possible to prevent the light guide sheet 30 from warping in the direction perpendicular to the light exit surface 30a.

Even when the light source support 52 expands or contracts in the arrangement direction of the LED chips 50, the corner close to the long hole 52b can be shifted in the arrangement direction of the LED chips 50 and thus the expansion and contraction of the light source support 52 is not regulated.

While the LED chips 50 each preferably have a rectangular shape with the short side lying in the thickness direction of the light guide sheet 30 for a thinner design of the light source unit 28, the invention is not limited thereto and LED chips having various shapes such as a square shape, a circular shape, a polygonal shape, and an elliptical shape may be used.

Next, the light guide sheet 30 will be described below.

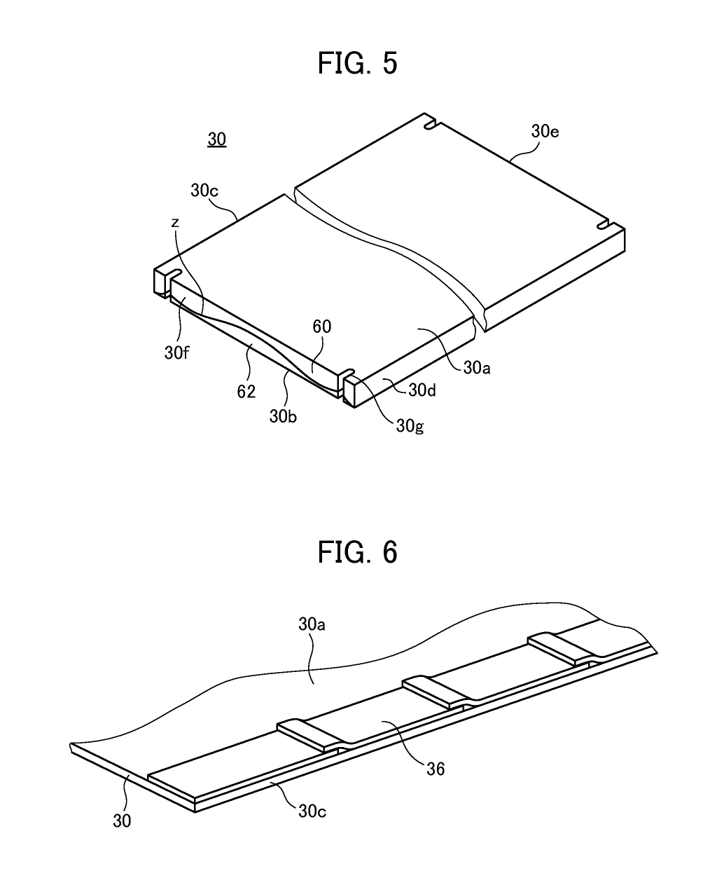

FIG. 5 is a schematic perspective view showing the shape of the light guide sheet 30.

The light guide sheet 30 is a sheet-like member with a thickness of 2 mm or less. As shown in FIGS. 2, 3A, 3B, and 5, the light guide sheet 30 includes the rectangular light exit surface 30a, the two light incidence surfaces (the first light incidence surface 30c and the second light incidence surface 30d) formed at both ends on the long side of the light exit surface 30a so as to be substantially perpendicular to the light exit surface 30a, a flat rear surface 30b located on the opposite side of the light exit surface 30a, that is, on the back side of the light guide sheet 30, and two side surfaces 30e and 30f that are adjacent to the light exit surface 30a and the two light incidence surfaces (30c and 30d).

Notches 30g having the same shape in cross-section parallel to the light exit surface 30a are formed on the two side surfaces 30e and 30f in the vicinity of the light incidence surfaces (30c and 30d). Convex portions of the side fixing member 66 engage with the notches 30g. This will be described later.

The two light sources 28 mentioned above are disposed so as to face the first light incidence surface 30c and the second light incidence surface 30d of the light guide sheet 30, respectively. In this embodiment, the light-emitting face 58 of each LED chip 50 in the light source units 28 has substantially the same length as the first light incidence surface 30c and the second light incidence surface 30d in the direction substantially perpendicular to the light exit surface 30a.

Thus, the backlight unit 20 has the two light sources 28 disposed so as to interpose the light guide sheet 30 therebetween. In other words, the light guide sheet 30 is disposed between the two light source units 28 facing each other with a predetermined gap therebetween.

The light guide sheet 30 is formed by kneading and dispersing scattering particles for scattering light into a transparent resin. Exemplary materials of the transparent resin used for the light guide sheet 30 include optically transparent resins such as PET (polyethylene terephthalate), PP (polypropylene), PC (polycarbonate), PMMA (polymethyl methacrylate), benzyl methacrylate, MS resin, and COP (cycloolefin polymer). Silicone particles such as TOSPEARL (registered trademark), silica particles, zirconia particles, dielectric polymer particles, and the like may be used as the scattering particles to be kneaded and dispersed into the light guide sheet 30.

The light guide sheet 30 has a two-layer structure including a first layer 60 on the side closer to the light exit surface 30a and a second layer 62 on the side closer to the rear surface 30b. When the boundary between the first layer 60 and the second layer 62 is referred to as “interface z”, the first layer 60 has a sectional region surrounded by the light exit surface 30a, the first light incidence surface 30c, the second light incidence surface 30d, and the interface z. On the other hand, the second layer 62 is a layer adjacent to the first layer 60 on the side closer to the rear surface 30b and has a sectional region surrounded by the interface z and the rear surface 30b.

The light guide sheet 30 is partitioned into the first layer 60 and the second layer 62 by the interface z, but the first layer 60 and the second layer 62 are different from each other in only particle concentration, have a configuration in which the same scattering particles are dispersed in the same transparent resin, and are structurally integrated. That is, when the light guide sheet 30 is partitioned with the interface z as a reference, the particle concentrations of the regions are different from each other, but the interface z is only a virtual surface and the first layer 60 and the second layer 62 are integrated.

When the particle concentration of the scattering particles in the first layer 60 and the particle concentration of the scattering particles in the second layer 62 are denoted by Npo and Npr, respectively, Npo and Npr have a relationship expressed by Npo<Npr. That is, in the light guide sheet 30, the second layer on the side closer to the rear surface 30b contains the scattering particles at a higher particle concentration than the first layer on the side closer to the light exit surface 30a.

When seen from a cross-section perpendicular to the longitudinal direction of the light incidence surface, the interface z between the first layer 60 and the second layer 62 continuously varies so that the second layer 62 has the largest thickness at a position corresponding to the bisector α (that is, the central portion of the light exit surface?) and the second layer 62 decreases in thickness from the position corresponding to the bisector a toward the first light incidence surface 30c and the second light incidence surface 30d, and then continuously varies so that the second layer temporarily increases in thickness in the vicinity of the first light incidence surface 30c and the second light incidence surface 30d and then decreases in thickness again.

Specifically, the interface z includes a curved surface convex toward the light exit surface 30a in the central portion of the light guide sheet 30, concave curved surfaces smoothly connected to the convex curved surface, and concave curved surfaces connected to the concave curved surfaces and connected to ends of the light incidence surfaces 30c and 30d on the side closer to the rear surface 30b. The thickness of the second layer 62 on the light incidence surfaces 30c and 30d is zero.

In this way, the thickness of the second layer 62 containing scattering particles at a higher particle concentration than that in the first layer 60 continuously varies so that the second layer has a first local maximum value in thickness in the vicinities of the light incidence surfaces and a second local maximum value at the central portion of the light guide sheet having the largest thickness. Accordingly, the combined particle concentration of the scattering particles varies so as to have the first local maximum value in the vicinity of each of the first and second light incidence surfaces (30c and 30d) and the second local maximum value at the central portion of the light guide sheet, the second local maximum value being larger than the first local maximum value.

The combined particle concentration in the invention means a concentration of scattering particles expressed using the amount of scattering particles added (combined) in a direction substantially perpendicular to the light exit surface at a position spaced apart from one light incidence surface toward the other on the assumption that the light guide sheet is a flat plate having the thickness at the light incidence surfaces throughout the light guide sheet. In other words, the combined particle concentration means the number of scattering particles per unit volume or a weight percentage with respect to the base material of scattering particles added in a direction substantially perpendicular to the light exit surface at a position spaced apart from the light incidence surface on the assumption that the light guide sheet is a flat light guide sheet which has the thickness of the light incidence surfaces throughout the light guide sheet and which has the same concentration.

Examples of the method of producing the light guide sheet 30 include a method of forming a base film containing scattering particles and serving as the first layer through the use of an extrusion molding method or the like, applying a monomer resin liquid (liquid of a transparent resin) in which scattering particles are dispersed to the formed base film and then irradiating the base film with ultraviolet rays or visible rays to cure the monomer resin liquid to thereby form the second layer having a desired particle concentration and obtain a film-like light guide sheet. Alternatively, the light guide sheet 30 may be produced by two-layer extrusion molding.

The first local maximum value in thickness of the second layer 62 (combined particle concentration) is located at the edge of an opening 44a of the upper housing 44 to be described later (see FIG. 2). The regions from the light incidence surfaces 30c and 30d to their corresponding positions of the first local maximum value are located outside the opening 44a of the upper housing 44, that is, in the frame portion forming the opening 44a, and thus does not contribute to the emission of light as the backlight unit 20. In other words, the regions from the light incidence surfaces 30c and 30d to their corresponding positions of the first local maximum value are so-called mixing zones M for diffusing light having entered through the light incidence surfaces. The region which is closer to the central portion of the light guide sheet than the mixing zones M, that is, the region corresponding to the opening 44a of the upper housing 44, is an effective screen area E and is a region contributing to the emission of light as the backlight unit 20.

By adjusting the combined particle concentration of the light guide sheet 30 (thickness of the second layer) so as to have the second local maximum value which is the largest in the central portion of the light guide sheet, light entering through the light incidence surfaces 30c and 30d can travel to positions farther from the light incidence surfaces 30c and 30d even if the light guide sheet is large and thin, whereby outgoing light has a luminance distribution which is high in the middle.

By adjusting the combined particle concentration so as to have the first local maximum value in the vicinities of the light incidence surfaces 30c and 30d, light entering through the light incidence surfaces 30c and 30d can be sufficiently diffused in the vicinities of the light incidence surfaces to prevent outgoing light through the vicinities of the light incidence surfaces from forming visible bright lines (dark lines, unevenness) due to intervals at which the light sources are disposed, or the like.

By adjusting the combined particle concentration so that the regions on the sides closer to the light incidence surfaces 30c and 30d than the positions where the combined particle concentration takes the first local maximum value have a lower combined particle concentration than the first local maximum value, return light, which is light outgoing through the light incidence surfaces after it once enters the light guide sheet, and outgoing light through the regions in the vicinities of the light incidence surfaces (mixing zones M) which are not used because the regions are covered with the housing can be reduced to improve the use efficiency of outgoing light through the effective region of the light exit surface (effective screen area E).

The adjustment of the shape of the interface z enables the luminance distribution (the concentration distribution of scattering particles) as well to be set as desired to improve the efficiency to the maximum extent possible.

In addition, since the particle concentration of the layer on the side closer to the light exit surface is reduced, the total amount of scattering particles used can be reduced, thereby leading to cost reduction.

By forming the light guide sheet out of a film-like member with a thickness of 2 mm or less, the light guide sheet can be made to be flexible, that is, can be formed as a flexible light guide sheet. Accordingly, it is possible to deform the light guide sheet in various forms and thus to form the surface of the light guide sheet as various curved surfaces.

By making the light guide sheet flexible, the planar lighting device using the light guide sheet may be mounted on a wall having a curvature, for example, when it is used as a decorative illumination or a general illumination. Accordingly, the planar light device can be used for decorative illuminations or general illuminations of a larger number of types or a wider use range.

When the light guide sheet is used in a curved surface, the housing is formed to correspond to the curved surface and receives and supports the light guide sheet formed in the curved shape.

In the light guide sheet 30 shown in FIG. 2, light emitted from the light source units 28 and allowed to enter the light guide sheet 30 through the first light incidence surface 30c and the second light incidence surface 30d is scattered by a scattering material (scattering particles) contained in the light guide sheet 30, as it travels through the inside of the light guide sheet 30, and is emitted through the light exit surface 30a directly or after having been reflected by the rear surface 30b. At this time, part of light may leak through the rear surface 30b but the leaked light is reflected by a reflector 34 disposed on the side closer to the rear surface 30b of the light guide plate 30 and enters the light guide sheet 30 again. The reflector 34 will be described later in detail.

In the illustrated example, the combined particle concentration is adjusted so as to have the first local maximum value at the edge of the opening 44a of the upper housing 44, but the invention is not limited to this configuration. That is, the combined particle concentration may have the first local maximum value at positions inside the opening 44a or in the frame portion of the surface of the upper housing 44 having the opening 44a (outside the opening 44a), as long as the combined particle concentration has the first local maximum value near the edge of the opening 44a of the upper housing 44. In other words, the combined particle concentration may have the first local maximum value at positions in the effective screen area E or at positions in the mixing zones M.

In a cross-section perpendicular to the longitudinal direction of the light incidence surface, the concave curved surfaces and the convex curved surfaces forming the interface z may be curves expressed as parts of a circle or an ellipse, quadratic curves, curves expressed by polynomials, or combined curves thereof.

Further, the particle concentration Npo of the scattering particles in the first layer 60 and the particle concentration Npr of the scattering particles in the second layer 62 preferably satisfy the relationships of 0 wt %<Npo<0.15 wt % and Npo<Npr<0.4 wt %.

When the first layer 60 and the second layer 62 of the light guide sheet 30 satisfy the above relationships, the light guide sheet 30 can guide incident light to the inside (center) of the light guide sheet 30 without scattering the incident light so much in the first layer 60 having a lower particle concentration, and the light is scattered by the second layer 62 having a higher particle concentration as it approaches the center of the light guide sheet, thereby increasing the amount of light emitted through the light exit surface 30a. In brief, the illuminance distribution which is high in the middle at a preferable ratio can be obtained while further enhancing the light use efficiency.

The particle concentration [wt %] mentioned herein means a ratio of the weight of the scattering particles to the weight of the base material.

Alternatively, the particle concentration Npo of the scattering particles in the first layer 60 and the particle concentration Npr of the scattering particles in the second layer 62 preferably satisfy the relationships of Npo=0 wt % and 0.01 wt %<Npr<0.4 wt %. In other words, the light guide sheet may be configured such that the scattering particles are not kneaded or dispersed in the first layer 60 so as to guide incident light to the depths of the light guide sheet 30 and the scattering particles are kneaded and dispersed in only the second layer 62 so as to further scatter the light as it approaches the center of the light guide sheet, thereby increasing the amount of light emitted through the light exit surface 30a.

Since the first layer 60 and the second layer 62 of the light guide sheet 30 satisfy the above-mentioned relationships, the illuminance distribution which is high in the middle at a preferable ratio can be obtained while further enhancing the light use efficiency.

In the illustrated example, the light guide sheet 30 is formed to include two layers having different particle concentrations, but the light guide sheet 30 may include a single layer or multiple layers of three or more layers.

The interface z between the first layer 60 and the second layer 62 has such a shape to have the first local maximum value and the second local maximum value, but the invention is not limited thereto and any shape such as a convex shape to the light exit surface may be used as long as it can suitably emit light through the light exit surface.

In this embodiment, the film-like light guide sheet with a thickness of 2 mm or less is used, but the thickness of the light guide sheet is not particularly limited and a light guide sheet with a thickness of several millimeters may be used.

In addition, the rear surface of the light guide sheet 30 is a plane parallel to the light exit surface 30a, but the invention is not limited thereto. The rear surface may be an inclined surface inclined in a direction in which the thickness of the light guide sheet increases as it gets apart from the light incidence surface or an inclined surface inclined in a direction in which the thickness of the light guide sheet decreases as it gets apart from the light incidence surface.

In the illustrated example, the light exit surface 30a is a plane, but the invention is not limited thereto. The light exit surface may be a concave surface. By employing the concave surface as the light exit surface, it is possible to prevent the light guide sheet from warping toward the light exit surface upon expansion or contraction of the light guide sheet due to heat or moisture, thus from coming contact with the liquid crystal display.

In the illustrated example, the light guide sheet 30 in which the scattering particles are kneaded and dispersed is employed, but the invention is not limited thereto. Various light guide sheets such as a light guide sheet having patterns formed on the light exit surface or the rear surface through printing or the like may be employed.

The surface of the light guide sheet 30 is preferably subjected to hard coating. By performing the hard coating on the surface of the light guide sheet 30, it is possible to prevent the surface of the light guide sheet 30 from being damaged, even when the light guide sheet 30 is pinched by the clips 64. Particularly, when a film-like light guide sheet with a thickness of 2 mm or less is used, damage formed on the surface thereof is likely to be seen as luminance unevenness in the outgoing light. Accordingly, by performing the hard coating on the surface of the film-like light guide sheet with a thickness of 2 mm or less to prevent the surface from being damaged, it is possible to suppress bright spot unevenness or bright line unevenness.

The refractive index of the hard coating material is preferably set to a range of 1.43 to 1.65 and is more preferably set to the same refractive index as the refractive index of the light guide sheet 30. By setting the refractive index of the hard coating material to this range, it is possible to prevent light from being scattered out when the light enters the light guide sheet 30.

The thickness of the hard coating is preferably set to several μm to several tens of μm. When light is guided through the hard coating material, the light is partially absorbed and light emitted through the light exit surface 30a of the light guide sheet 30 may cause color unevenness. However, by setting the thickness of the hard coating to this range, the length of the optical path through the hard coating material decreases enough in comparison with the length by which light is guided from incidence to exit (the entire length of the optical path). Therefore, it is possible to reduce the influence of absorption of light in the hard coating material to the minimum and thus to prevent color unevenness in the outgoing light. A material less absorbing light can be more preferably used as the hard coating material.

A plasticizer may be mixed into the above-mentioned transparent resin to produce the light guide sheet.

By producing the light guide sheet using a material in which the transparent resin and a plasticizer are mixed, it is possible to make the light guide sheet more flexible and it is easier to deform the light guide sheet in various shapes, thereby enabling use of the light guide sheet for more applications.

Examples of the plasticizer include ester phthalates such as dimethyl phthalate (DMP), diethyl phthalate (DEP), dibutyl phthalate (DBP), di-2-ethylehexyl phthalate (DOP(DEHP)), di-n-octyl phthalate (DnOP), diisononyl phthalate (DINP), dinonyl phthalate (DNP), diisodecyl phthalate (DIDP), mixed-base ester phthalates (C6 to C11) (such as 610P and 711P), and butylbenzyl phthalate (BBP). In addition to ester phthalates, examples thereof further include dioctyl adipate (DOA), diisononyl adipate (DINA), di-n-alkyl adipate (C6, 8, 10) (610A), dialkyl adipate (C7, 9) (79A), dioctyl azelate (DOZ), dibutyl sebacate (DBS), dioctyl sebacate (DOS), tricresyl phosphate (TCP), acetyl tributyl citrate (ATBC), epoxidized soybean oil (ESBO), trimellitic acid trioctyl (TOTM), polyesters, and chlorinated paraffins.

Next, an upper light guide reflector 36 will be described below.

FIG. 6 is a schematic perspective view showing a part of the light guide sheet 30 and the upper light guide reflector 36 of the backlight unit shown in FIG. 3A.

The upper light guide reflector 36 is disposed to reflect light leaking from the light exit surface 30a in the vicinity of the light incidence surfaces (30c and 30d) of the light guide sheet 30 and to cause the reflected light to enter the light guide sheet 30 again. Accordingly, it is possible to improve incidence efficiency of light. A plurality of upper light guide reflectors 36 are disposed to cover ends of the light exit surface 30a of the light guide sheet 30 (an end closer to the first light incidence surface 30c and an end closer to the second light incidence surface 30d).

As shown in FIG. 6, each upper light guide reflector 36 is disposed so as to partially overlap with the adjacent upper light guide reflectors 36 in the longitudinal direction of the light incidence surfaces (30c and 30d) of the light guide sheet 30 and parts of the upper light guide reflectors 36 in contact with the light guide sheet 30 are allowed to adhere and fixed. One of the parts overlapping with the adjacent upper light guide reflectors 36 is allowed to adhere to the light guide sheet 30, but the other is not fixed and can slide over the other adjacent upper light guide reflector 36.

In this way, by disposing the upper light guide reflectors 36 so that the adjacent upper light guide reflectors 36 partially overlap with each other, even when the light guide sheet 30 expands/contracts due to heat or moisture and misregistration occurs between the light guide sheet 30 and the upper light guide reflectors 36, it is possible to absorb the misregistration between the light guide sheet 30 and the upper light guide reflectors 36. Therefore, even when the light guide sheet 30 expands, the upper light guide reflectors 36 can cover up the sides of the light exit surface 30a of the light guide sheet 30 closer to the light incidence surfaces (30c and 30d) and it is thus possible to prevent a decrease in light incidence efficiency.

The length of the upper light guide reflector 36 in the longitudinal direction of the light incidence surfaces (30c and 30d) of the light guide sheet 30 is not particularly limited and is preferably set to a range of 10 mm to 200 mm. The length of the upper light guide reflector 36 in the direction perpendicular to the light incidence surfaces (30c and 30d) is not particularly limited, and is preferably set to a range of 10 mm to 20 mm. By setting the size of the upper light guide reflector 36 to these ranges, light emitted from the light source units 28 can be suitably guided by the light guide sheet 30 even when the light guide sheet 30 expands or contracts.

The upper light guide reflectors 36 may be formed of any material as long as it can reflect light leaking from the ends of the light exit surface 30a of the light guide sheet 30 on the sides closer to the light incidence surfaces (30c and 30d). For example, the upper light guide reflectors 36 may be formed, for example, of a resin sheet produced by kneading a filler with PET or PP (polypropylene) and then drawing the resultant mixture to form voids therein for an increase in reflectance, a sheet with a specular surface formed on the surface of a transparent or white resin sheet, for example, by aluminum vapor deposition, a metal foil such as an aluminum foil or a resin sheet carrying a metal foil, or a thin metal sheet of which the surface has sufficient reflectivity.

In this way, by providing the upper light guide reflectors 36 at the ends of the light exit surface 30a of the light guide sheet 30 on the sides closer to the light incidence surfaces (30c and 30d), light emitted from the light source units 28 can be prevented from failing to enter the light guide sheet 30 and leaking through the light exit surface 30a.

A lower light guide reflector 38 is disposed to reflect light leaking from the rear surface 30b in the vicinity of the light incidence surfaces (30c and 30d) of the light guide sheet 30 and to cause the reflected light to enter the light guide sheet 30 again. Accordingly, the lower light guide reflector 38 can improve the light incidence efficiency. The end of the lower light guide reflector 38 on the side closer to the center of the light guide sheet 30 is connected to the reflector 34.

The above-mentioned various materials used for the upper light guide reflector 36 can be used as the lower light guide reflector 38.

In the illustrated example, the lower light guide reflector 38 is formed integrally with the reflector 34, but the invention is not limited thereto and both reflectors may be formed of different members. Similarly to the upper light guide reflectors 36, a plurality of lower light guide reflectors 38 may be arranged in the longitudinal direction of the light incidence surfaces (30c and 30d).

Next, the reflector 34 will be described below.

The reflector 34 is a plate-like member disposed to reflect light leaking from the rear surface 30 of the light guide sheet 30 and to cause the reflected light to enter the light guide sheet 30 again. Accordingly, the reflector 34 can improve the light use efficiency.

The above-mentioned various materials used for the upper light guide reflector 36 can be used as the reflector 34.

In the above-mentioned embodiment, the reflector 34 has a plate-like shape, but may be formed to cover the rear surface in a shape corresponding to the rear surface of the light guide sheet 30. For example, when the cross-section of the rear surface of the light guide sheet 30 is formed substantially in a V shape, the reflector 34 may also be formed in the corresponding shape.

The clips 64 are members for fixing the light guide sheet 30 and the light source unit 28 with a distance therebetween kept constant and a plurality of clips are arranged in the arrangement direction of the LED chips 50 (the longitudinal direction of the light incidence surface).

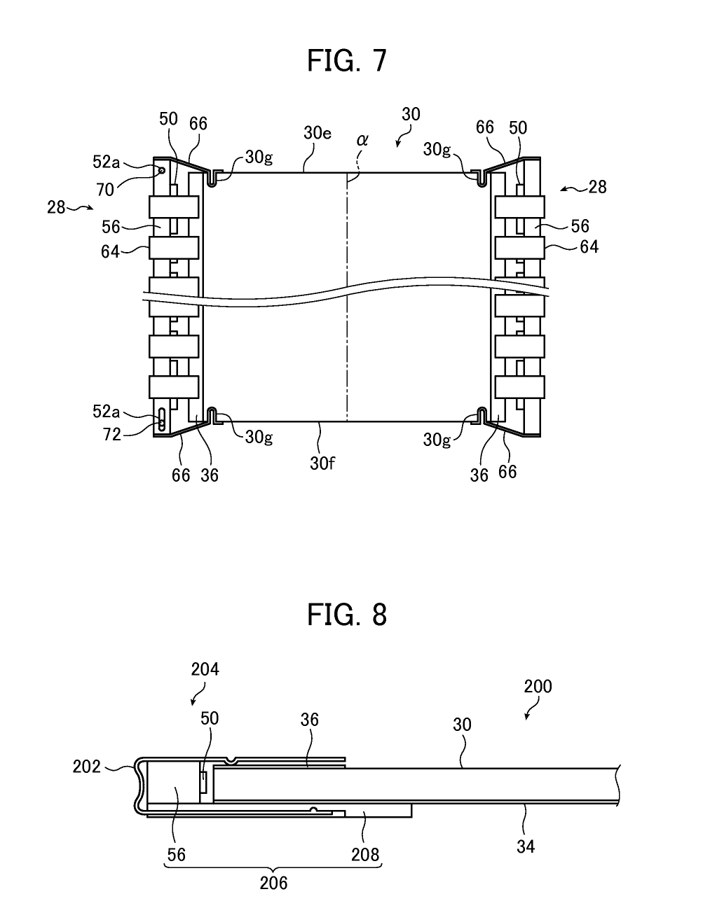

FIG. 7 is a plan view of the backlight unit 20 shown in FIG. 2.

As shown in FIGS. 2 and 7, the clips 64 hold the light guide sheet 30 and the light source units 28 by pinching and pressing the light guide sheet 30 and the light source units 28 in the direction perpendicular to the light exit surface 30a. Specifically, each clip 64 is a plate-like member having a substantially C-shaped cross-section and is energized with elasticity in a direction in which the opening is closed.

Each clip 64 is disposed at a position of the clip insertion portion 54a formed in the substrate section 54 of the light source support 52, one opening edge thereof is allowed to pass through the clip insertion portion 54a, and the clip pinches the support section 56 of the light source unit 28 and the end of the light guide sheet 30 on the side closer to the light incidence surface (30c or 30d).

The clips 64 pinch and press the support sections 56 of the light source units 28 and the ends of the light guide sheet 30 on the sides closer to the light incidence surfaces (30c and 30d), which are located inside the openings of the clips 64, from the direction perpendicular to the light exit surface 30a. Accordingly, the clips 64 hold the light guide sheet 30 and the light source units 28 in a state where the distance between the light incidence surfaces (30c and 30d) and the LED chips 50 is kept constant.

In the illustrated example, the upper light guide reflectors 36 and the lower light guide reflector 38 are disposed on the surface on the sides closer to the light exit surface 30a and the rear surface 30b of the light guide sheet 30. Therefore, the clips 64 pinch the light guide sheet 30 with the upper light guide reflectors 36 and the lower light guide reflector 38 interposed therebetween.

In this way, the plurality of clips for pressing and pinching the light guide sheet 30 and the light source units 28 in the direction perpendicular to the light exit surface 30a are disposed in the longitudinal direction of the light incidence surfaces (30c and 30d) of the light guide sheet 30 so as to hold the light guide sheet 30 and the light source units 28. Accordingly, even when expansion and contraction or warpage occurs in the light guide sheet due to heat or moisture absorption, the light guide sheet is deformed due to vibration, or the light guide sheet is curved for use, the light source units 28 move integrally with the light guide sheet 30 and thus the distance and the positional relationship between the light incidence surfaces (30c and 30d) and the LED chips 50 can be appropriately maintained. As a result, it is possible to prevent a decrease in light use efficiency and to guide incident light to the depths of the light guide sheet, thereby achieving uniform illumination.

The plurality of clips 64 are arranged in the arrangement direction of the LED chips 50 (the longitudinal direction of the light incidence surfaces) to hold the light guide sheet 30 and the light source units 28. Accordingly, even when the light guide sheet 30 expands or contracts in the longitudinal direction of the light incidence surfaces, the expansion or contraction of the light guide sheet 30 is not regulated and thus the light guide sheet 30 can be prevented from warping in the direction perpendicular to the light exit surface 30a.

Since a complex mechanism is not necessary, the light source units 28 and the light guide sheet 30 can be surely fixed in spite of the decrease in thickness of the light guide sheet 30. Since a complex mechanism is not used, it is possible to reduce a cost and to further decrease the thickness of the backlight unit 20.

The length of the clip 64 in the arrangement direction of the LED chips 50 and the arrangement intervals of the clips 64 are not particularly limited, as long as the light guide sheet 30 and the light source units 28 can be held in a state where the distance and the positional relationship between the light incidence surfaces (30c and 30d) and the LED chips 50 are appropriately kept constant without regulating the expansion and contraction of the light guide sheet 30, and can be appropriately determined depending on the material or size of the light guide sheet.

The side fixing members 66 are plate-like members that are fixed to two side surfaces of the support section 56 of the light source units 28 (end surfaces in the longitudinal direction of the support section 56) and that have elasticity in the arrangement direction of the LED chips 50, and each include a convex portion engaging with the notches 30g formed in the side surfaces 30e and 30f of the light guide sheet 30.

By causing the convex portions of the two side fixing members 66 disposed in the light source units 28 to engage with the respective notches 30g of the light guide sheet 30, the light guide sheet 30 and the light source units 28 can be held in a state where the distance and the positional relationship between the light incidence surfaces (30c and 30d) and the LED chips 50 are appropriately kept constant.

The side fixing members 66 have elasticity in the arrangement direction of the LED chips 50. Accordingly, even when the light guide sheet 30 expands or contracts in the arrangement direction of the LED chips 50, the side fixing members 66 are elastically deformed to correspond to the expansion and contraction of the light guide sheet 30. Therefore, expansion or contraction of the light guide sheet 30 is not regulated and the light guide sheet 30 can be prevented from warping in the direction perpendicular to the light exit surface.

Next, the optical member unit 32 will be described below.

The optical member unit 32 is disposed to convert illumination light emitted from the light exit surface 30a of the light guide sheet 30 into light with less luminance unevenness and less illuminance unevenness and to emit the resultant light from the light exit surface 24a of the lighting device main body 24. As shown in FIG. 2, the optical member unit 32 comprises a diffusion sheet 32a for diffusing the illumination light emitted from the light exit surface 30a of the light guide sheet 30 to reduce luminance unevenness and illuminance unevenness, a prism sheet 32b having microprism arrays formed thereon parallel to the lines where the light exit surface 30a and the light incidence surfaces 30c, 30d meet, and a diffusion sheet 32c for diffusing the illumination light emitted from the prism sheet 32b to reduce luminance unevenness and illuminance unevenness.

The diffusion sheets 32a and 32c and the prism sheet 32b are not particularly limited, and known diffusion sheets and prism sheets may be used. For example, the diffusion sheets and the prism sheets disclosed in paragraphs [0028] to [0033] of JP 2005-234397 A, which has been field by the applicant of the invention, may be used.

While the optical member unit in this embodiment comprises two diffusion sheets 32a and 32c and the prism sheet 32b disposed between the two diffusion sheets, there is no particular limitation on the order in which the prism sheet and the diffusion sheets are arranged or the number of the sheets to be used. The materials of the prism sheet and the diffusion sheets are also not particularly limited, and use may be made of various optical members, as long as they can further reduce the luminance unevenness and illuminance unevenness of the illumination light emitted from the light exit surface 30a of the light guide sheet 30.

For example, the optical members used in addition to or instead of the above-described diffusion sheets and prism sheet may be transmittance adjusting members in which a large number of transmittance adjusters consisting of diffusion reflectors are disposed depending on the luminance unevenness and the illuminance unevenness. Further, the optical member unit may have a two-layer structure including one prism sheet and one diffusion sheet or including two diffusion sheets only.

Next, the housing 26 will be described below.

As shown in FIG. 2, the housing 26 receives and supports the lighting device main body 24 and holds and secures the lighting device main body 24 from the side closer to the light exit surface 24a and the side closer to the rear surface 30b of the light guide sheet 30. The housing 26 comprises the lower housing 42 and the upper housing 44.

The lower housing 42 is open at the top and has a shape formed by a bottom section and lateral sections provided upright on four sides of the bottom section. In brief, the lower housing 42 has a substantially rectangular box shape of which one surface is open. As shown in FIG. 2, the lower housing 42 supports the lighting device main body 24 received therein from above on the bottom section and the lateral sections and covers the surfaces of the lighting device main body 24 other than the light exit surface 24a, that is, the opposite surface of the lighting device main body 24 to the light exit surface 24a (rear surface) and the lateral surfaces thereof.

The upper housing 44 has the shape of a rectangular box which has at the top a rectangular opening 44a smaller than the rectangular light exit surface 24a of the lighting device main body 24 and which is open at the bottom.

As shown in FIG. 2, the upper housing 44 is disposed to cover the lighting device main body 24, the lower housing 42 receiving the main body, and the four lateral sections from above the lighting device main body 24 and the lower housing 42 (from the light exit surface side).

The fixing pins 70 and 72 are fixed to the housing 26 (the upper housing 44 and the lower housing 42). As described above, the fixing pins 70 and 72 engage with the round hole 52a and the longitudinal hole 52b formed in the light source support 52 of the light source unit 28, respectively, to suspend the light source unit 28.

The backlight unit 20 is basically configured as described below.

In the backlight unit 20, light emitted from the light source units 28 disposed at both ends of the light guide sheet 30 enters the light incidence surfaces (the first light incidence surface 30c and the second light incidence surface 30d) of the light guide sheet 30. The light entering from the respective surfaces is scattered by the scattering material contained in the light guide sheet 30 as the light travels inside the light guide sheet 30 and is emitted from the light exit surface 30a directly or after being reflected by the rear surface 30b. At this time, a part of the light leaking from the rear surface is reflected by the reflector 34 and enters the light guide sheet 30 again.

In this way, the light emitted from the light exit surface 30a of the light guide sheet 30 passes through the optical member 32 and is emitted from the light exit surface 24a of the lighting device main body 24, thereby illuminating the liquid crystal display panel 12.

The liquid crystal display panel 12 uses the drive unit 14 to control the light transmittance according to the position so as to display characters, figures, images and the like on the surface of the liquid crystal display panel 12.

While the clips 64 in the illustrated example hold the light guide sheet 30 and the light source units 28 by pinching and pressing the light guide sheet and the light source units, the invention is not limited to this configuration. The clips may hold the light guide sheet and the light source units by pressing the light guide sheet and the light source units in a state where a part of the light guide sheet and a part of the light source units overlap with each other.

FIG. 8 is a schematic cross-sectional view showing a part of another example of the backlight unit according to the invention. The backlight unit 200 shown in FIG. 8 has the same configuration as the backlight unit 20, except that clips 202 are provided instead of the clips 64 and light source units 204 are provided instead of the light source units 28. Accordingly, like elements will be referenced by like reference numerals and the different elements will be principally described below.

The backlight unit 200 shown in FIG. 8 comprises a light guide sheet 30, light source units 204 disposed to face light incidence surfaces (30c and 30d) of the light guide sheet 30, and clips 202.

Each light source unit 204 comprises a light source support 206 and a plurality of LED chips 50 which are arranged in the light source support 206.

The light source support 206 comprises a support section 56 supporting the LED chips 50 and a substrate section 208.

The substrate section 208 is a plate-like member which is formed on the surface of the support section 56 on the side closer to the rear surface 30b of the light guide sheet 30 and extends on the rear surface 30b of the light guide sheet 30. Concave portions to which the convex portions formed in the clips 202 are fitted are formed on the opposite surface of the substrate section 208 to the support section 56.

The clips 202 are members for fixing the light guide sheet 30 and the light source unit 204 with the distance therebetween kept constant and a plurality of clips are arranged in the arrangement direction of the LED chips 50 (the longitudinal direction of the light incidence surfaces).

Each clip 202 is a plate-like member having a substantially C-shaped cross-section and is energized with elasticity in the direction in which the opening is closed. One opening edge of the clip 202 presses the light guide sheet and the light source unit in the direction perpendicular to the light exit surface 30a from the side closer to the light guide sheet 30 and the other opening edge presses the light guide sheet and the light source unit in the direction perpendicular to the light exit surface 30a from the side closer to the substrate section 208 of the light source support 204. Accordingly, the light guide sheet 30 and the light source support 204 can be pinched and held in a state where they overlap with each other in the direction perpendicular to the light exit surface 30a.

Convex portion which is fitted to the concave portion of the substrate section 208 is formed at the opening edge of the clip 202 on the side closer to the substrate section 208.

In this way, by causing the clips 202 to press the light guide sheet 30 and the light source unit 204 in a state where a part of the light guide sheet 30 and a part of the light source unit 204 overlap with each other, the light guide sheet 30 and the light source unit 204 are held. Accordingly, even when expansion and contraction or warpage occurs in the light guide sheet 30 due to heat or moisture absorption, the light guide sheet 30 is deformed due to vibration, or the light guide sheet 30 is curved for use, the light source units 204 move integrally with the light guide sheet 30 and thus the distance and the positional relationship between the light incidence surfaces (30c and 30d) and the LED chips 50 can be appropriately maintained. As a result, it is possible to prevent a decrease in light use efficiency and to guide incident light to the depths of the light guide sheet 30, thereby achieving uniform illumination.

The plurality of clips 202 are arranged in the arrangement direction of the LED chips 50 (the longitudinal direction of the light incidence surfaces) to hold the light guide sheet 30 and the light source units 204. Accordingly, even when the light guide sheet 30 expands or contracts in the longitudinal direction of the light incidence surfaces, the expansion or contraction of the light guide sheet 30 is not regulated and thus the light guide sheet 30 can be prevented from warping in the direction perpendicular to the light exit surface 30a.

Since a complex mechanism is not necessary, the light source units 204 and the light guide sheet 30 can be surely fixed in spite of the decrease in thickness of the light guide sheet 30. Since a complex mechanism is not used, it is possible to reduce a cost and to further decrease the thickness of the backlight unit.

By respectively forming the concave portion and convex portion in the clip 202 and the substrate section 208 to engage with each other, the clip 202 can be prevented from moving in the direction perpendicular to the light incidence surfaces (30c and 30d) and thus the clip 202 can be prevented from coming out of position.

While the illustrated example has the configuration in which the concave portion and the convex portion are respectively formed in the clip 202 and the substrate section 208 to engage with each other, the invention is not limited to this configuration, and a configuration in which the convex portion is formed at the opening edge of the clip closer to the light guide sheet and the concave portion is formed in the light guide sheet to engage with each other may be employed.

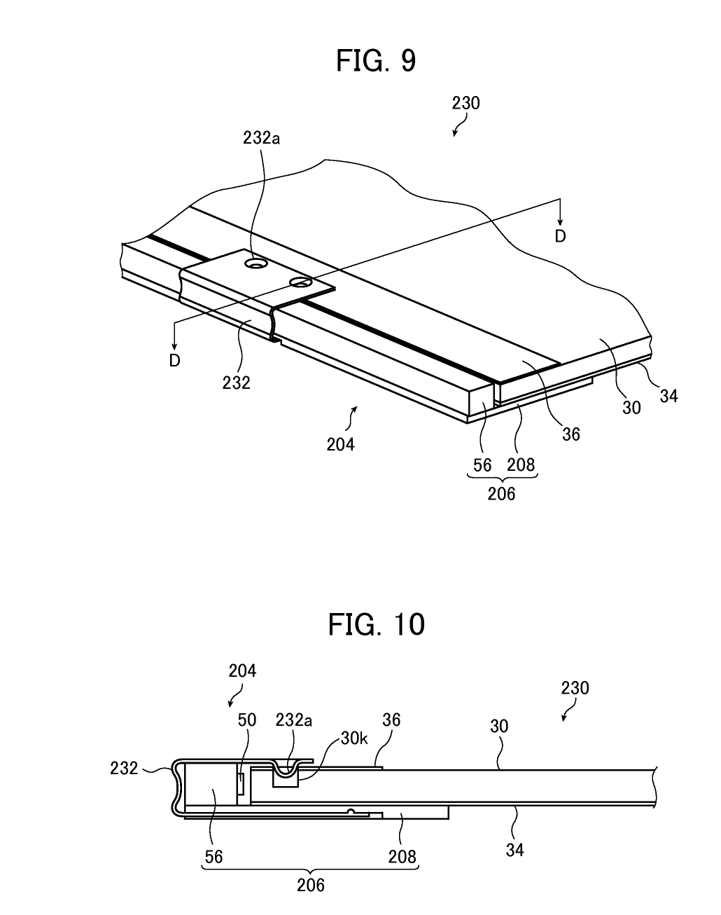

FIG. 9 is a schematic perspective view showing a part of another example of the backlight unit according to the invention and FIG. 10 is a cross-sectional view of FIG. 9. taken along line D-D. In FIG. 9, the side fixing members 66 and the like are not shown. The backlight unit 230 shown in FIG. 9 has the same configuration as the backlight unit 200, except that clips 232 are provided instead of the clips 202 and locking holes 30k are formed in the light guide sheet 30. Accordingly, like elements will be referenced by like reference numerals and the different elements will be principally described below.

The backlight unit 230 shown in FIGS. 9 and 10 comprises a light guide sheet 30, light source units 204 disposed to face light incidence surfaces (30c and 30d) of the light guide sheet 30, upper light guide reflectors 36, and clips 232.

In the light exit surface 30a in the vicinity of the light incidence surfaces of the light guide sheet 30, locking holes 30k engaging with embossed portions 232a of the clips 232 are arranged and formed at predetermined intervals in the longitudinal direction of the light incidence surfaces. In the illustrated example, the locking holes 30k are blind holes.

The shape of the locking holes 30k are not particularly limited and various shapes such as a round hole, a long hole, or a rectangular hole can be used. The shape of the locking holes 30k is preferably a long hole having a long axis the direction of which is the arrangement direction of the LED chips 50. By setting the shape of the locking holes 30k to a long hole, the expansion and contraction of the light guide sheet 30 is not suppressed due to the engagement of the locking holes 30k and the embossed portions 232a of the clips 232 even when the light guide sheet 30 expands or contracts, and thus it is possible to prevent the light guide sheet 30 from warping.

Holes are also formed in the upper light guide reflectors 36 disposed on the side closer to the light exit surface 30a of the light guide sheet 30 to correspond to the locking holes 30k.

Each clip 232 is a member for fixing the light guide sheet 30 and the light source unit 204 with the distance therebetween kept constant and a plurality of clips 232 are arranged in the arrangement direction of the LED chips 50 (the longitudinal direction of the light incidence surfaces). Since each clip 232 has the same configuration as the clip 202 except that an embossed portion 232a is formed at an opening edge on the side closer to the light guide sheet 30, different elements will be principally described below.

The embossed portion 232a is a semi-spherical convex portion that is formed at an opening edge of the clip 232 disposed on the side closer to the light guide sheet 30 and that engages with the locking hole 30k of the light guide sheet 30. In the illustrated example, two embossed portions 232a arranged in the arrangement direction of the LED chips 50 are formed in each clip 232. In the embossed portion 232a, the semi-spherical convex portion and a flat portion are smoothly connected.

In this way, by causing the clips 232 to press the light guide sheet 30 and the light source unit 204 in a state where a part of the light guide sheet 30 and a part of the light source unit 204 overlap with each other, the light guide sheet 30 and the light source unit 204 are held. Accordingly, even when expansion and contraction occurs in the light guide sheet 30 due to heat or moisture absorption or the light guide sheet 30 is curved for use, the light source units 204 move integrally with the light guide sheet 30 and thus the distance and the positional relationship between the light incidence surfaces (30c and 30d) and the LED chips 50 can be appropriately maintained. As a result, it is possible to prevent a decrease in light use efficiency and to guide incident light to the depths of the light guide sheet 30, thereby achieving uniform illumination.

The clips 232 are arranged in the arrangement direction of the LED chips 50 to hold the light guide sheet 30 and the light source units 204. Accordingly, even when the light guide sheet 30 expands or contracts in the longitudinal direction of the light incidence surfaces, the expansion or contraction of the light guide sheet 30 is not regulated and thus the light guide sheet 30 can be prevented from warping.

Since a complex mechanism is not necessary, the light source units 204 and the light guide sheet 30 can be surely fixed in spite of the decrease in thickness of the light guide sheet 30 and it is possible to reduce a cost and to further decrease the thickness of the backlight unit.

By causing the embossed portions 232a formed in the clips 232 and the locking holes 30k formed in the light guide sheet 30 to engage with each other, the clips 232 can be prevented from moving in the direction perpendicular to the light incidence surfaces (30c and 30d) and thus the clips 232 can be prevented from coming out of position.

While the shape of the convex portions formed in the clips 232 in the illustrated example is set to the semi-spherical embossed shape, the invention is not limited to this configuration and various shapes can be used as long as they can engage with the locking hole 30k. While the locking holes 30k formed in the light guide sheet 30 in the illustrated example are blind holes, the invention is not limited to this configuration but through holes may be used.

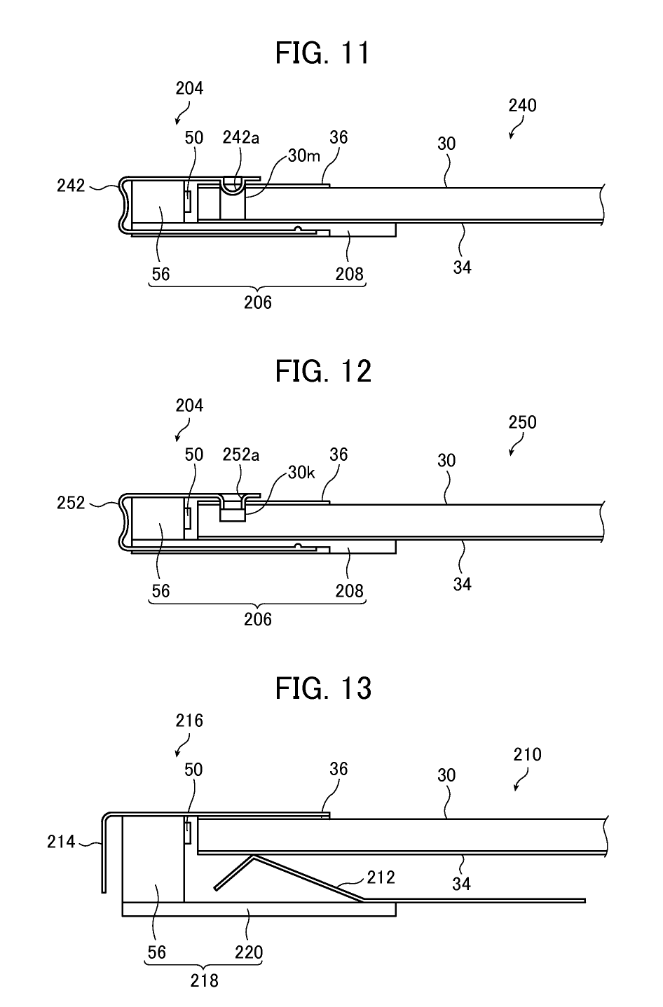

FIG. 11 is a cross-sectional view showing a part of another example of the backlight unit according to the invention. The backlight unit 240 shown in FIG. 11 has the same configuration as the backlight unit 230, except that the light guide sheet 30 has locking holes 30m instead of the locking holes 30k and clips 242 having an embossed portion 242a formed therein instead of the embossed portion 232a are provided. Accordingly, like elements will be referenced by like reference numerals and the different elements will be principally described below.

The backlight unit 240 shown in FIG. 11 comprises a light guide sheet 30, light source units 204 disposed to face light incidence surfaces (30c and 30d) of the light guide sheet 30, upper light guide reflectors 36, and clips 242.

In the light exit surface 30a in the vicinity of the light incidence surfaces of the light guide sheet 30, locking holes 30m engaging with the embossed portions 242a of the clips 242 are arranged and formed at predetermined intervals in the longitudinal direction of the light incidence surfaces. In the illustrated example, the locking holes 30m are through holes. Similarly to the locking holes 30k, the shape of the locking holes 30m is not particularly limited and various shapes such as a round hole, a long hole, or a rectangular hole can be used.

Each clips 242 is a member for fixing the light guide sheet 30 and the light source unit 204 with the distance therebetween kept constant and a plurality of clips 242 are arranged in the arrangement direction of the LED chips 50 (the longitudinal direction of the light incidence surfaces).

The embossed portion 242a is a semi-spherical convex portion that is formed at an opening edge of the clip 242 disposed on the side closer to the light guide sheet 30 and that engages with the locking hole 30m of the light guide sheet 30. In the embossed portion 242a of the illustrated example, the semi-spherical convex portion and a flat portion are vertically connected.

FIG. 12 is a cross-sectional view showing a part of another example of the backlight unit according to the invention. The backlight unit 250 shown in FIG. 12 has the same configuration as the backlight unit 230, except that clips 252 having a burring portion 252a formed therein instead of the embossed portion 232a are provided. Accordingly, like elements will be referenced by like reference numerals and the different elements will be principally described below.

The backlight unit 250 shown in FIG. 12 comprises a light guide sheet 30, light source units 204 disposed to face light incidence surfaces (30c and 30d) of the light guide sheet 30, upper light guide reflectors 36, and clips 252.

Each clips 252 is a member for fixing the light guide sheet 30 and the light source unit 204 with the distance therebetween kept constant and a plurality of clips 252 are arranged in the arrangement direction of the LED chips 50 (the longitudinal direction of the light incidence surfaces).

The burring portion 252a is a convex portion that is formed at an opening edge of the clip 252 disposed on the side closer to the light guide sheet 30 and that engages with the locking hole 30k of the light guide sheet 30. The burring portion 252a is formed by a burring process.

The shape of the convex portion formed in the clip can be various shapes as long as it can engage with the locking hole. The locking hole formed in the light guide sheet may be a blind hole or a through hole. By causing the convex portion formed in the clip and the concave portion formed in the light guide sheet to engage with each other, the clip can be prevented from moving in the direction perpendicular to the light incidence surface and thus the clip can be prevented from coming out of position.

While the backlight unit 20 has the configuration in which the light guide sheet and the light source units are held by the clips, the invention is not limited to this configuration.

FIG. 13 is a cross-sectional view schematically showing a part of another example of the backlight unit according to the invention.

The backlight unit 210 shown in FIG. 13 has the same configuration as the backlight unit 20, except that the clip 64 is replaced with a first fixing spring member 212 and a second fixing spring member 214 and the light source units 28 are replaced with light source units 216. Accordingly, like elements will be referenced by like reference numerals and the different elements will be principally described below.

The backlight unit 210 shown in FIG. 13 comprises a light guide sheet 30, light source units 216 disposed to face light incidence surfaces (30c and 30d) of the light guide sheet 30, and pairs of a first fixing spring member 212 and a second fixing spring member 214.

Each light source unit 216 comprises a light source support 218 and a plurality of LED chips 50 arranged in the light source support 218.

The light source support 218 comprises a support section 56 supporting the LED chips 50 and a substrate section 220.

The substrate section 220 is a plate-like member which is formed on the surface of the support section 56 on the side closer to the rear surface 30b of the light guide sheet 30 and extends on the rear surface 30b of the light guide sheet 30. The first fixing spring member 212 is fixed to the surface of the substrate section 220 on the side closer to the rear surface 30b.

The first fixing spring member 212 is a plate-like member (leaf spring) that is fixed to the substrate section 220 of the light source support 218 and that extends at the position facing the rear surface 30b of the light guide sheet 30. The first fixing spring member 212 has elasticity in the direction perpendicular to the light exit surface 30a and presses the light guide sheet 30 from the side of the rear surface 30b.

The second fixing spring member 214 is a plate-like member (leaf spring) that is fixed to the support section 56 of the light source support 218 and that extends at the position facing the light exit surface 30a of the light guide sheet 30. The second fixing spring member 214 has elasticity in the direction perpendicular to the light exit surface 30a and presses the light guide sheet 30 from the side of the light exit surface 30a.

The light guide sheet 30 is held by the first fixing spring member 212 pressing the light guide sheet 30 from the side of the rear surface 30b and the second fixing spring member 214 pressing the light guide sheet 30 from the side of the light exit surface 30a.

In this way, the first fixing spring member 212 fixed to the light source support 218 so as to press the light guide sheet 30 from the side of the rear surface 30b and the second fixing spring member 214 fixed to the light source support 218 so as to press the light guide sheet from the side of the light exit surface 30a are provided. Accordingly, even when expansion and contraction or warpage occurs in the light guide sheet 30 due to heat or moisture absorption, the light guide sheet 30 is deformed due to vibration, or the light guide sheet 30 is curved for use, the light source units 216 move integrally with the light guide sheet 30 and thus the distance and the positional relationship between the light incidence surfaces (30c and 30d) and the LED chips 50 can be appropriately maintained. As a result, it is possible to prevent a decrease in light use efficiency and to guide incident light to the depths of the light guide sheet 30, thereby achieving uniform illumination.

Plural pairs of fixing spring members (the first fixing spring member 212 and the second fixing spring member 214) are arranged in the arrangement direction of the LED chips 50 (the longitudinal direction of the light incidence surfaces) to hold the light guide sheet 30 and the light source units 216. Accordingly, even when the light guide sheet 30 expands or contracts in the longitudinal direction of the light incidence surfaces, the expansion or contraction of the light guide sheet 30 is not regulated and thus the light guide sheet 30 can be prevented from warping in the direction perpendicular to the light exit surface 30a.

Since a complex mechanism is not necessary, the light source units 216 and the light guide sheet 30 can be surely fixed in spite of the decrease in thickness of the light guide sheet 30. Since a complex mechanism is not used, it is possible to reduce a cost and to further decrease the thickness of the backlight unit.

While the planar lighting device according to the invention has been described in detail, the invention is not limited to the above-mentioned embodiment and may be improved or modified in various forms without departing from the gist of the invention.

For example, while double-side incidence in which the light source units are disposed on two light incidence surfaces of the light guide sheet is employed in the illustrated examples, the invention is not limited to this configuration and single-side incidence in which a single light source unit is disposed on one light incidence surface may be employed. By reducing the number of light source units, the number of components can be reduced, thereby reducing cost.

Alternatively, a light source unit may be disposed on the side surfaces of the light guide sheet in addition to the two light incidence surfaces. By increasing the number of light sources, it is possible to enhance the intensity of light emitted from the device.

What is claimed is:

1. A planar lighting device comprising:
a light guide sheet having a rectangular light exit surface, one or more light incidence surfaces, the one light incidence surface being disposed on an end side of the light exit surface and to which light traveling in a direction parallel to the light exit surface enters, and a rear surface which is an opposite surface of the light exit surface;
one or more light source units, the one light source having a light source disposed to face the one light incidence surface of the light guide sheet and a light source support member that supports the light source; and
a plurality of fixing spring members that press and hold the light guide sheet and the one or more light source units in a direction perpendicular to the light exit surface of the light guide sheet, that have elasticity in a direction perpendicular to the light exit surface, and that are arranged in a longitudinal direction of the one light incidence surface of the light guide sheet.

2. The planar lighting device according to claim 1, wherein each fixing spring member is a clip member which has a substantially C shape and of which two opening ends hold the light guide sheet and the one or more light source units by pinching and pressing the light guide sheet and the one or more light source units.

3. The planar lighting device according to claim 1, wherein the light source support member has a portion overlapping with the light guide sheet in a direction perpendicular to the light exit surface, and
wherein each fixing spring member is a clip member which has a substantially C shape and which holds the light source support member and the light guide sheet in a state where a part of the light source support member and the light guide sheet overlap with each other in the direction perpendicular to the light exit surface by causing one opening edge to press the light source support member and the light guide sheet in the direction perpendicular to the light exit surface from a side closer to the light guide sheet and causing the other opening edge to press the light source support member and the light guide sheet in the direction perpendicular to the light exit surface from a side closer to the light source support member.

4. The planar lighting device according to claim 1, wherein each fixing spring member comprises a first fixing spring member that is fixed to the light source support member so as to press the light guide sheet from a side closer to the rear surface and a second fixing spring member that is fixed to the light source support member so as to press the light guide sheet from a side closer to the light exit surface.

5. The planar lighting device according to claim 1, wherein the light exit surface of the light guide sheet is provided with a plurality of locking holes arranged and formed in a longitudinal direction of the one light incidence surface in the vicinity of the one light incidence surface, and
wherein a portion of each fixing spring member which presses the light guide sheet from the side of the light exit surface is provided with a convex portion engaging with the locking hole.

6. The planar lighting device according to claim 1, further comprising side fixing members that are fixed to the light source support member, that extend to face two side surfaces which are adjacent to the light exit surface and the one or more light incidence surfaces of the light guide sheet, that have convex engaging portions toward the side surfaces, and that have elasticity in the direction perpendicular to the side surfaces of the light guide sheet,
wherein notches are formed on the side surfaces of the light guide sheet, respectively, and
wherein the engaging portions of the side fixing members engage with the notches formed on the side surfaces of the light guide sheet.

7. The planar lighting device according to claim 1, wherein the thickness of the light guide sheet in the direction perpendicular to the light exit surface is equal to or less than 2 mm.

8. The planar lighting device according to claim 1, wherein one or more ends of at least one of the light exit surface and the rear surface of the light guide sheet closer to the one or more light incidence surfaces are provided with one or more reflecting members.

9. The planar lighting device according to claim 8, wherein the one reflecting member comprises a plurality of light guide reflectors arranged in an extending direction of the one light incidence surface and adheres to the end of the light exit surface or of the rear surface of the light guide sheet closer to the one light incidence surface.

10. The planar lighting device according to claim 9, wherein each light guide reflector is disposed to partially overlap with adjacent light guide reflectors.

11. The planar lighting device according to claim 1, wherein the light source comprises a plurality of point light sources facing the one or more light incidence surfaces and arranged in an extending direction of the one or more light incidence surfaces.

12. The planar lighting device according to claim 1, wherein a surface of the light guide sheet is covered with a hard coating material which is optically transparent.

13. The planar lighting device according to claim 12, wherein the hard coating material has a refractive index of 1.43 to 1.65.

14. The planar lighting device according to claim 1, wherein the light guide sheet has scattering particles kneaded and dispersed therein.

15. The planar lighting device according to claim 14, wherein the light guide sheet has two or more layers which are superposed in a direction perpendicular to the light exit surface and which have different particle concentrations of the scattering particles.

16. The planar lighting device according to claim 1, wherein the light incidence surfaces consist of two light incidence surfaces disposed on two end sides of the light exit surface facing each other, and
wherein the light source units consist of two light source units which are arranged to face the two light incidence surfaces, respectively.

17. The planar lighting device according to claim 1, wherein the one light incidence surface is disposed on an end side of the light exit surface, and
wherein the one light source unit is arranged to face the single light incidence surface.
